(19) United States
(12) Patent Application Publication
(10) Pub. No.: US 2024/0354018 A1
(43) Pub. Date: Oct. 24, 2024

(54) STORAGE SYSTEM WITH BAD BLOCKS, AND OPERATING METHOD THEREOF

(71) Applicant: SAMSUNG ELECTRONICS CO., LTD., Suwon-si (KR)

(72) Inventors: Jin-Hee MA, Suwon-si (KR); Kyuho SON, Suwon-si (KR); Yunho YANG, Suwon-si (KR); Sangyoon OH, Suwon-si (KR); Wonchul LEE, Suwon-si (KR); Jaigyun LIM, Suwon-si (KR)

(73) Assignee: SAMSUNG ELECTRONICS CO., LTD., Suwon-si (KR)

(21) Appl. No.: 18/378,452

(22) Filed: Oct. 10, 2023

(30) Foreign Application Priority Data
Apr. 24, 2023 (KR) 10-2023-0053489

(51) Int. Cl. G06F 3/06

(52) U.S. Cl. CPC G06F 3/064; G06F 3/0607; G06F 3/0679; G06F 12/0253

(57) ABSTRACT

The present disclosure provides methods and apparatuses for a storage system. In some embodiments, a storage system includes a plurality of storage devices and a host device. Each storage device of the plurality of storage devices includes a plurality of blocks classified into first type blocks, second type blocks, and third type blocks, and is configured to generate internal state information items indicating information on a first number of first type blocks, a second number of second type blocks, and a third number of third type blocks. The host device is configured to receive, from the plurality of storage devices, the internal state information items, generate target state information such that the plurality of storage devices include a same number or substantially same number of first type blocks, based on the internal state information items, and transmit, to the plurality of storage devices, the target state information.

### CROSS-REFERENCE TO RELATED APPLICATION

This application claims benefit of priority under 35 U.S.C. § 119 to Korean Patent Application No. 10-2023-0053489, filed on Apr. 24, 2023, in the Korean Intellectual Property Office, the disclosure of which is incorporated by reference herein in its entirety.

### BACKGROUND

### 1. Field

The present disclosure relates generally to a storage system, and more particularly, to storage systems with bad blocks, and operating methods thereof.

### 2. Description of Related Art

Flash memories may refer to non-volatile memories that may be characterized by an ability to retain stored data even though power may be cut off. In recent years, storage devices including flash memories, such as, but not limited to solid state drives (SSDs) and/or memory cards, have been widely used. Unfortunately, due to various reasons, some dies included in some non-volatile memories may be determined as failure dies. Failure dies may refer to dies in which the number of bad blocks occurring on the die may be greater than a reference number (e.g., a threshold). Recently, approaches have emerged to utilize storage devices including non-volatile memories with failure dies. However, the time needed to access a storage device including failure dies may be different (e.g., greater) from the time needed to access another storage device without failure dies.

Thus, there exists a need for further improvements in storage device technology, as the need for uniform performance across storage devices with and without bad blocks may be constrained by differences in the access times of these storage devices. Improvements are presented herein. These improvements may also be applicable to other semiconductor technologies and the standards that employ these technologies.

### SUMMARY

Aspects of the present disclosure provide for a storage device and a storage system capable of providing uniform performance even when including a non-volatile memory device including bad blocks.

According to an aspect of the present disclosure, a storage system is provided. The storage system includes a plurality of storage devices and a host device. Each storage device includes a plurality of blocks classified into first type blocks, second type blocks, and third type blocks, and is configured to generate internal state information items indicating information on a first number of first type blocks, a second number of second type blocks, and a third number of third type blocks. The host device is configured to receive, from the plurality of storage devices, the internal state information items, generate target state information such that the plurality of storage devices include a same number or substantially same number of first type blocks, based on the internal state information items, and transmit, to the plurality of storage devices, the target state information.

According to an aspect of the present disclosure, a server is provided. The server includes a communication unit and a controller. The communication unit is configured to receive a plurality of internal state information items from a plurality of storage devices. Each storage device of the plurality of storage devices includes a memory cell array including a plurality of blocks. Each internal state information item of the plurality of internal state information items includes information on a first number of first type blocks of the plurality of blocks configured to perform garbage collection, a second number of second type blocks of the plurality of blocks configured as not readable and not writable, and a third number of third type blocks which are writable and readable. The controller is configured to set, by generating target state information, a first target number of first type blocks and a third target number of third type blocks in each storage device of the plurality of storage devices, based on the plurality of internal state information items.

According to an aspect of the present disclosure, an operating method of a storage system is provided. The operating method includes transmitting, by a host device to a plurality of storage devices, a state check signal. The operating method further includes receiving, from the plurality of storage devices by the host device. The internal state information items includes information on a first number of first type blocks of a corresponding storage device configured to perform garbage collection, a second number of second type blocks of the corresponding storage device configured as not readable and not writable, and a third number of third type blocks configured as readable and writeable. The operating method further includes generating, by the host device, target state information for each storage device of the plurality of storage devices such that the plurality of storage devices comprise a same number or substantially same number of first type blocks, based on the internal state information items of the plurality of storage devices. The operating method further includes transmitting, by the host device to the plurality of storage devices, a state change signal including the target state information and instructing the plurality of storage devices to change the internal state information items such that each storage device of the plurality of storage devices matches the target state information.

Additional aspects may be set forth in part in the description which follows and, in part, may be apparent from the description, and/or may be learned by practice of the presented embodiments.

### BRIEF DESCRIPTION OF DRAWINGS

The above and other aspects, features, and advantages of certain embodiments of the present disclosure may be more apparent from the following description taken in conjunction with the accompanying drawings, in which:

FIG. 1 is a drawing illustrating a storage system, according to an embodiment;

FIG. 2 is a drawing illustrating a host device, according to an embodiment;

FIG. 3 is a drawing illustrating a storage device, according to an embodiment;

FIG. 4 is a block diagram illustrating an example of a non-volatile memory which is included in a storage device, according to an embodiment;

FIG. 5 is a drawing illustrating the number of blocks in the storage device, according to an embodiment;

FIG. 6 is a flow chart illustrating the operation of the storage system, according to an embodiment;

FIG. 7 is a drawing illustrating internal state information items which are respectively related to a plurality of storage devices, according to an embodiment;

FIG. 8 is a flow chart illustrating the operation of the host device, according to an embodiment;

FIG. 9 is a drawing illustrating internal state information items on the plurality of individual storage devices, according to an embodiment;

FIG. 10 is a flow chart illustrating the operation of a storage device, according to an embodiment; and

FIG. 11 is a block diagram illustrating a data center to which the storage system, according to an embodiment.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness.

With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

It is to be understood that when an element or layer is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

The terms “first,” “second,” third” may be used to described various elements but the elements are not limited by the terms and a “first element” may be referred to as a “second element”. Alternatively or additionally, the terms “first”, “second”, “third”, and the like may be used to distinguish components from each other and do not limit the present disclosure. For example, the terms “first”, “second”, “third”, and the like may not necessarily involve an order or a numerical meaning of any form.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

Hereinafter, various embodiments of the present disclosure are described with reference to the accompanying drawings.

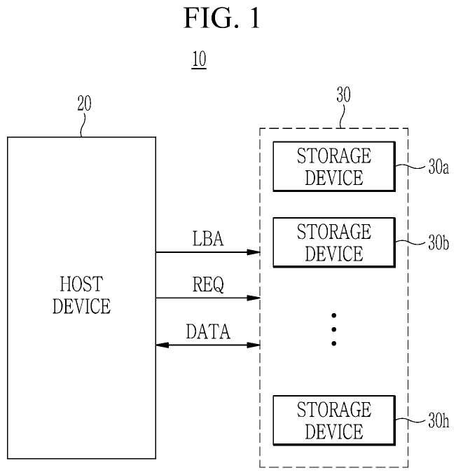

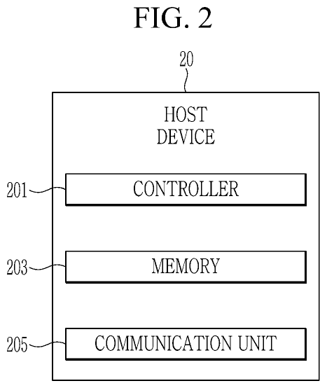

FIG. 1 is a drawing illustrating a storage system, according to an embodiment. FIG. 2 is a drawing illustrating a host device, according to an embodiment.

In an embodiment, a storage system 10 may be included in user devices such as, but not limited to, a personal computer (PC), a desktop computer, a laptop, a server, a virtual machine, a network appliance, a media player, a digital camera, automotive devices (e.g., a navigation system, a black box, an automotive electronic device), and/or the like. Alternatively or additionally, the storage system 10 may be included in a mobile system such as, but not limited to, a mobile phone, a smart phone, a tablet PC, a personal digital assistant (PDA), a wearable device (e.g., smart watch, headset, headphones, and the like), a smart device (e.g., a voice-controlled virtual assistant, a set-top box (STB), a refrigerator, an air conditioner, a microwave, a television, and the like), a healthcare device, an Internet of Things (IoT) device, and the like.

As shown in FIG. 1, the storage system 10 may include a host device 20 and a plurality of storage devices 30 (e.g., first storage device 30a, second storage device 30b, to h-th storage device 30h, where h is a positive integer greater than zero (0), hereinafter generally referred to as “30”).

The host device 20 may control the overall operation of the storage system 10.

The host device 20 may perform communication with the storage devices 30 through various interfaces. For example, the host device 20 may perform communication with the storage devices 30 through various interfaces such as, but not limited to, universal serial bus (USB), MultiMediaCard (MMC), peripheral component interconnect (PCI) express (PCI-e), advanced technology (AT) attachment (ATA), serial AT attachment (SATA), parallel AT attachment (PATA), small computer system interface (SCSI), serial attached SCSI (SAS), enhanced small disk interface (ESDI), integrated drive electronics (IDE), non-volatile memory (NVM) express (NVMe), and the like.

In an embodiment, the host device 20 may provide logical block addresses LBA and/or request signals REQ to the storage devices 30. Alternatively or additionally, the host device 20 may transmit and/or receive data DATA to and/or from the plurality of storage devices 30.

As shown in FIG. 2, the host device 20 may include a controller 201, a memory 203, and a communication unit 205.

The controller 201 may control the operation of the host device 20 (such as, but not limited to, computation, logic, control, input/output, and the like). For example, the controller 201 may transmit a request signal REQ to each storage device of the plurality of storage devices 30 through the communication unit 205. As another example, the request signal REQ may include an initialization signal for initializing the plurality of storage devices 30. Alternatively or additionally, the request signal REQ may include a state check signal for obtaining an internal state information item on each of the plurality of storage devices 30. In an optional or additional embodiment, the request signal REQ may include a state change signal for changing the current internal state of each of the plurality of storage devices 30 to a target internal state. The internal state information items may include block information items on the block configurations of the memory arrays in the storage devices 30. Alternatively or additionally, the internal state information items may further include garbage collection level setting information items needed for the plurality of storage devices 30 to perform garbage collection. Target internal state information items may include target block information items on block configurations to which the storage devices 30 are to be changed. Alternatively or additionally, the target internal state information items may further include information items on target garbage collection levels to which current garbage collection levels are to be changed. In some embodiments, the host device 20 may generate a state change signal based on the internal state information items received respectively from the plurality of storage devices 30.

The controller 201 may be and/or may include, for example, a central processing unit (CPU), a graphic processing unit (GPU), a microprocessor, and/or an application processor (AP). However, the present disclosure is not limited in this regard.

The memory 203 may store instructions and/or data, which may be executed and processed by the controller 201. For example, an operating system which may be executed by the controller 201 may include a file system for managing files, and device drivers for controlling peripheral devices including the plurality of storage devices 30 at the level of the operating system.

The communication unit 205 may perform communication with the plurality of storage devices 30. For example, the communication unit 205 may receive internal state information items on the plurality of storage devices 30, from the plurality of storage devices 30. Alternatively or additionally, the communication unit 205 may receive target internal state information items generated by the controller 201, and transmit them to the plurality of storage devices 30.

Each of the plurality of storage devices 30 may be accessed by the host device 20. In an embodiment, the plurality of storage devices 30 may be implemented in the form of a solid-state drive (SSD), a smart SSD, an embedded multimedia card (eMMC), an embedded universal flash storage (UFS) memory device, a UFS memory card, compact flash (CF), secure digital (SD), micro secure digital (Micro-SD), mini secure digital (Mini-SD), extreme digital (xD), a memory stick, and/or the like.

In some embodiments, each of the plurality of storage devices 30 may be connected to the host device 20 through a block accessible interface including buses such as, but not limited to, SATA buses, SCSI buses, NVMe buses, SAS buses, UFS, eMMC, and the like.

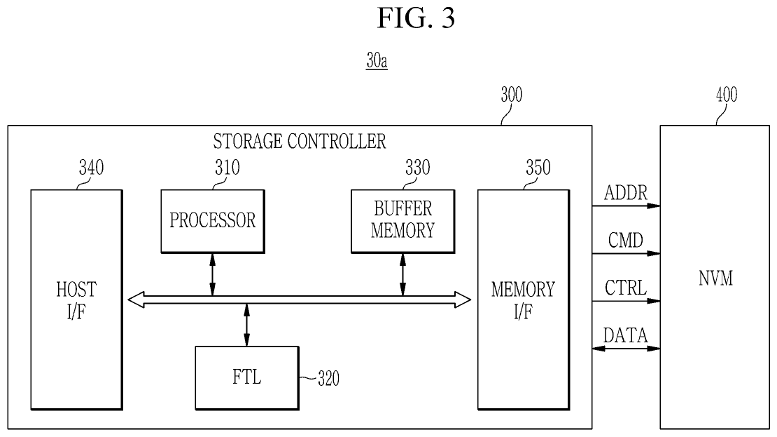

FIG. 3 is a drawing illustrating a storage device, according to the embodiment. The storage device 30a of FIG. 3 may include and/or may be similar in many respects to any of the storage devices 30 described above with reference to FIG. 1, and may include additional features not mentioned above. Consequently, repeated descriptions of the storage device 30a described above with reference to FIG. 1 may be omitted for the sake of brevity.

Referring to FIG. 3, the storage device 30a may include a storage controller 300 and a non-volatile memory 400. The storage device 30a may store data DATA and/or process data DATA in response to a request signal REQ from the host device 20, as described with reference to FIG. 1.

In an embodiment, the storage controller 300 may control the operation of the storage device 30a. For example, the storage controller 300 may provide an address ADDR, a command CMD, a control signal CTRL, and/or the like to the non-volatile memory 400, in response to a logical block address LBA, a request signal REQ, and/or the like received from the host device 20. That is, the storage controller 300 may provide signals to the non-volatile memory 400, write data in the non-volatile memory 400, and/or read data from the non-volatile memory 400. Alternatively or additionally, the storage controller 300 and the non-volatile memory 400 may exchange data DATA.

For example, the storage controller 300 may include a processor 310, a flash translation layer (FTL) 320, a buffer memory 330, a host interface 340, a memory interface 350, and the like.

The processor 310 may control the overall operation of the storage controller 300. For example, the processor 310 may run (e.g., execute) firmware loaded on the FTL 320, and thereby be capable of controlling the storage controller 300 by executing the firmware. In some embodiments, the processor 310 may be and/or may include, but not be limited to, a CPU, a controller, an application specific integrated circuit (ASIC), and/or the like.

In an embodiment, the processor 310 may run various firmware and/or software which may be said to run in the storage controller 300. For example, the processor 310 may use the buffer memory 330 as an operational memory for the processor 310. Alternatively or additionally, the processor 310 may use the non-volatile memory 400 and/or the memory 203 as an operational memory for the processor 310.

For example, the processor 310 may control the operation of reading data from the non-volatile memory 400 and/or the operation of programming data in the non-volatile memory 400 by executing firmware.

The host interface 340 may transmit and/or receive packets to and/or from a host device (e.g., host device 20 of FIG. 1). In an embodiment, packets which may be transmitted from the host device 20 to the host interface 340 may include, but not be limited to, commands, data to be written in a non-volatile memory (e.g., the plurality of storage devices 30 of FIG. 1), and the like. Alternatively or additionally, packets which may be transmitted from the host interface 340 to the host device 20 may include responses to commands, data read from the non-volatile memory 400, and the like.

The memory interface 350 may provide signal transmission and/or reception with the non-volatile memory 400. For example, the memory interface 350 may transmit commands and/or control signals together with data to be written in the non-volatile memory 400, to the non-volatile memory 400. As another example, the memory interface 350 may receive data read from the non-volatile memory 400. In an embodiment, the memory interface 350 may be implemented so as to conform to at least one communication standard such as, but not limited to, Toggle and/or Open NAND Flash Interface (ONFI).

The flash translation layer (FTL) 320 may include firmware and/or software for managing a data writing operation, a data read operation, a sub-block and/or block erasing operation, and the like, to be performed on the non-volatile memory 400. The firmware of the FTL 320 may be executed by the processor 310. In some embodiments, the FTL 320 may be implemented with various hardware automation circuits configured to perform the above-described operations, as well as, various maintenance operations. That is, the FTL 320 may be implemented in hardware, and the above-mentioned various maintenance operations may be performed by the hardware.

In an embodiment, the FTL 320 may perform various maintenance operations for potentially maintaining the efficiency of the non-volatile memory 400. For example, the FTL 320 may perform various maintenance-related functions such as, but not limited to, address mapping, wear-leveling, and garbage collection.

The FTL 320 may perform an address mapping operation of converting a logical block address received from the host device 20 into a physical address to be used to actually store data in the non-volatile memory 400. For example, the FTL 320 may perform mapping between a logical block address from the host device 20 and a physical address of the non-volatile memory 400, using an address mapping table. The address mapping operation may be an operation of performing conversion and/or mapping between a logical block address which may be managed by the host device 20 and a physical address of the non-volatile memory 400. In some embodiments, the address mapping table may include information on addresses assigned to a plurality of blocks depending on the types of blocks such as, but not limited to, free blocks, user blocks, and reserved blocks.

The FTL 320 may perform wear-leveling on a plurality of blocks. The wear-leveling operation may refer to an operation of equalizing the frequencies of use of the plurality of memory blocks included in the non-volatile memory 400, and/or the numbers of times of use of the plurality of memory blocks. For example, the wear-leveling operation may be implemented in firmware and/or hardware for balancing the erase counts of physical blocks. In some embodiments, the wear-leveling operation may be performed not only in units of a block but also in units of a plurality of physical sub-blocks constituting each block. For example, the FTL 320 may perform wear-leveling such that usage may be even among the plurality of sub-blocks of each of the plurality of blocks in the non-volatile memory 400. In some embodiments, the FTL 320 may evenly use each of the plurality of memory blocks of the non-volatile memory 400 by the wear-leveling operation, thereby being capable of preventing excessive deterioration of certain memory blocks. Accordingly, it may be possible to improve the lifetime of the non-volatile memory 400.

The FTL 320 may perform garbage collection for securing available capacity in the non-volatile memory 400. The garbage collection operation may refer to an operation of copying valid data from blocks of the non-volatile memory 400 into new blocks and erasing the existing blocks such that the existing blocks may be reused. For example, since the non-volatile memory 400 cannot be overwritten, when a request to write new data on a page with data written thereon may be received from the host device 20, the storage controller 300 may write the new data on a new page of the non-volatile memory 400. Consequently, the existing page with the data written thereon may be invalidated. The process of removing invalidated pages and combining only pages with valid data written thereon, which may be performed by the FTL 320, may be referred to as garbage collection. When garbage collection is performed, besides a user's data writing request, additional programming and/or erasing operations may occur. As a result, the additional operations may cause a decrease in the performance of the storage device 30a. As such, as the ratio of the area available for garbage collection within the memory area increases (e.g., as the number of times the garbage collection operation may be performed decreases), the performance of the storage device 30a may improve.

In some embodiments, the FTL 320 may perform the garbage collection operation when the available memory area in the non-volatile memory 400 exceeds a preset garbage collection level. The garbage collection level may be a threshold set that may be used by the FTL 320 to determine the start of garbage collection. In some embodiments, the garbage collection operation may be performed on a sub-block basis, as well as, a block basis.

In optional or additional embodiments, the FTL 320 also perform operations according to requests from the host device 20. For example, the FTL 320 may perform an operation for checking the state of the non-volatile memory 400, in response to a state check signal from the host device 20. In some embodiments, the FTL 320 may store block information of the non-volatile memory 400. For example, the block information may include the total number of blocks included in the non-volatile memory 400, the types of the blocks, the number of blocks corresponding to each block type, and an address corresponding to each block type. In an embodiment, the FTL 320 may set a garbage collection level based on the block information. For example, the FTL 320 may count the number of first type blocks varying according to a writing operation, and perform garbage collection when the number of first type blocks is smaller (e.g., less) than a threshold. As another example, the FTL 320 may determine whether the available memory area in the non-volatile memory 400 may be equal to or below the preset garbage collection level, on the basis of the internal state information on the non-volatile memory 400.

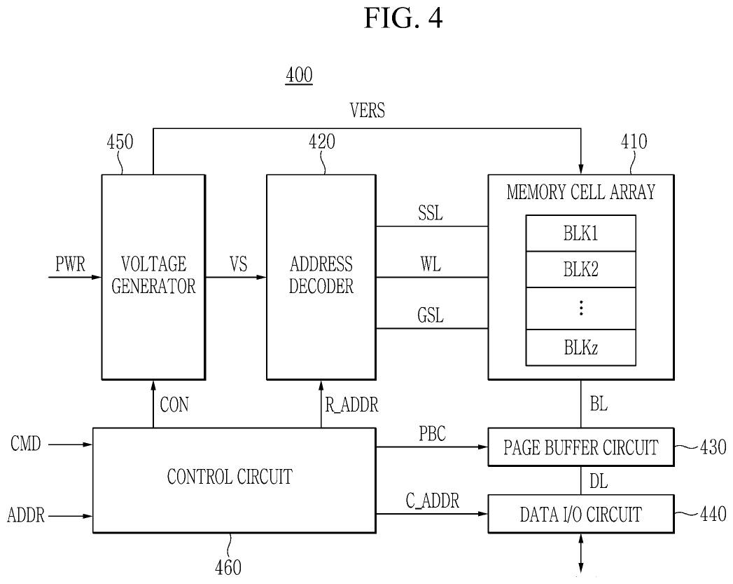

In some embodiments, the FTL 320 may change an address mapping table assigned to each type of the plurality of blocks in order to change the state of the non-volatile memory 400, in response to a state change signal from the host device 20. For example, the FTL 320 may change the internal state information on the non-volatile memory 400, as target block information, on the basis of a state change signal. As another example, when the number of first type blocks and the number of second type blocks in the target block information are different from the number of first type blocks and the number of second type blocks in the internal state information, respectively, the FTL 320 may assign addresses set as addresses corresponding to the first type blocks of the target non-volatile memory 400, as addresses for second type blocks, and/or assign addresses set as addresses corresponding to the second type blocks, as addresses for first type blocks, thereby changing the internal state information on the non-volatile memory 400 as target block information. These operations are further described with reference to FIGS. 3 and 4.

When the internal state information on the non-volatile memory 400 has been changed as target block information, the FTL 320 may determine whether the corresponding non-volatile memory 400 satisfies a minimum garbage collection level. For example, a storage system may include a first storage device that includes ten (10) first type blocks, twenty (20) second type blocks, five (5) third type blocks, and a second storage device that includes four (4) first type blocks, thirty (30) second type blocks, and ten (10) third type blocks. In such an example, the first storage device may perform garbage collection when the number of first type blocks becomes smaller (e.g., less) than or equal to ten (10). That is, the garbage collection level of the first storage device may correspond to ten (10) first type blocks. The second storage device may perform garbage collection when the number of first type blocks becomes smaller (e.g., less) than or equal to five (5). That is, the garbage collection level of the second storage device may correspond to five (5) first type blocks.

As another example, the host device 20 may generate target block information such that the first storage device and the second storage device have seven (7) first type blocks. For example, the host device 20 may generate target block information indicating seven (7) first type blocks, twenty-three (23) second type blocks, and five (5) third type blocks with respect to the first storage device, and/or may generate target block information including seven (7) first type blocks, twenty-seven (27) second type blocks, and ten (10) third type blocks with respect to the second storage device. In such an example, the first storage device has free blocks equal to or below the garbage collection level, which may be undesirable. Accordingly, the first storage device may change the preset garbage collection level.

In some embodiments, the FTL 320 may set a garbage collection level according to the number of first type blocks and/or the number of second type blocks, which may be stored in advance. For example, the FTL 320 may control the storage device 30a such that the storage device 30a has a first garbage collection level, when the storage device 30a has fewer first type blocks than a preset basic number of first type blocks by a predetermined level or more. Alternatively or additionally, the FTL 320 may control the storage device 30a such that the storage device 30a has a second garbage collection level, when the storage device 30a has the number of first type blocks falling within a predetermined range relative to the preset basic number of first type blocks. In an optional or additional embodiment, the FTL 320 may control the storage device 30a such that the storage device 30a has a third garbage collection level, when the storage device 30a has more first type blocks than the preset basic number of first type blocks by a predetermined level or more. However, the present disclosure is not limited thereto, and the FTL 320 may set garbage collection levels in various manners. Alternatively or additionally, the storage device 30a may transmit the manner of setting garbage collection levels to the host device 20, and the host device 20 may set a garbage collection level with respect to the storage device 30a, on the basis of target state information generated by the host device 20, and the manner of setting garbage collection levels received from the storage device 30a.

In some embodiments, the FTL 320 may store data that may be needed to perform the operation of the FTL 320. For example, the FTL 320 may store block information on the non-volatile memory 400, a garbage collection level for performing garbage collection on the non-volatile memory 400, an address mapping table that may be used for converting logical addresses of the host device 20 into physical addresses of the non-volatile memory 400, an address mapping table that may be managed by the garbage collection and/or wear-leveling operation, and the like. However, the present disclosure is not limited thereto, and other data that may be needed to perform the operation of the FTL 320 may be stored in the buffer memory 330, and/or may be stored in the non-volatile memory 400.

The buffer memory 330 may store instructions and/or data which may be executed and/or processed by the storage controller 300. The buffer memory 330 may temporarily store data that may be stored in the non-volatile memory 400 (e.g., read data) and/or may be assigned to be stored in the non-volatile memory 400 (e.g., write data).

In an embodiment, the buffer memory 330 may be implemented as a non-volatile memory such as, but not limited to, a dynamic random access memory (DRAM), a static random access memory (SRAM), and/or the like. However, the buffer memory 330 is not limited thereto, and may be implemented as various types of non-volatile memories, for example, a resistive non-volatile memory such as, but limited to, a magnetic RAM (MRAM), a phase change RAM (PRAM), or resistive RAM (ReRAM), a flash memory, a nano floating gate memory (NFGM), a polymer random access memory (PoRAM), a ferroelectric random access memory (FRAM), and the like.

In some embodiments, the buffer memory 330 may store code data that may be needed for initial booting of the storage device 30a. The buffer memory 330 may temporarily store logical block addresses LBA, request signals REQ, data DATA, commands, and the like, that may have been received from the host device 20. Signals temporarily stored in the buffer memory 330 may be transmitted to the non-volatile memory 400 through the memory interface 350, and be used. For example, data DATA temporarily stored in the buffer memory 330 may be programmed in the non-volatile memory 400.

Although as shown in FIG. 3, the buffer memory 330 is provided in the storage controller 300, the present disclosure is not limited thereto. For example, the buffer memory 330 may be provided outside of the storage controller 300.

The non-volatile memory 400 may include a plurality of dies and/or a plurality of chips including memory cell arrays. For example, the non-volatile memory 400 may include a plurality of chips, and each of the plurality of chips may include a plurality of dies. In an embodiment, the non-volatile memory 400 may also include a plurality of channels, each of which may include a plurality of chips.

The non-volatile memory 400 may include a NAND flash memory. In an optional or additional embodiment, the non-volatile memory 400 may include an electrically erasable programmable read-only memory (EEPROM), a phase change random access memory (PRAM), a resistive RAM (ReRAM), a resistance random access memory (RRAM), a nano floating gate memory (NFGM), a polymer random access memory (PoRAM), a magnetic random access memory (MRAM), a ferroelectric random access memory (FRAM), and the like. The following description will be made on the assumption that the non-volatile memory 400 in this disclosure is a NAND flash memory device.

Although as shown in FIG. 3, the storage device 30a includes one non-volatile memory 400, the present disclosure is not limited thereto. For example, the storage device 30a may include a plurality of non-volatile memories.

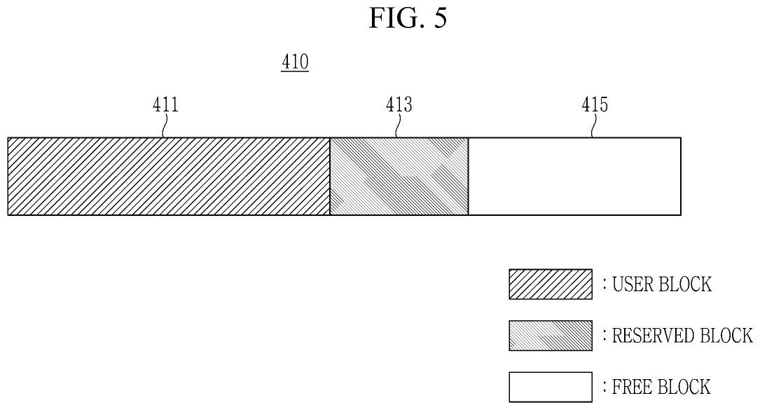

FIG. 4 is a block diagram illustrating an example of a non-volatile memory which may be included in a storage device, according to the embodiment. FIG. 5 is a drawing illustrating the number of blocks in the storage device, according to an embodiment.

Referring to FIG. 4, the non-volatile memory 400 may include a memory cell array 410, an address decoder 420, a page buffer circuit 430, a data I/O circuit 440, a voltage generator 450, and a control circuit 460.

The memory cell array 410 may be coupled to the address decoder 420 through a plurality of string select lines SSL, a plurality of word lines WL, and a plurality of ground select lines GSL. Alternatively or additionally, the memory cell array 410 may be coupled to the page buffer circuit 430 through a plurality of bit lines BL. The memory cell array 410 may include a plurality of memory cells, which may be coupled to the plurality of word lines WL and the plurality of bit lines BL.

In some embodiments, the memory cell array 410 may be formed in a two-dimensional (2D) array structure and/or a three-dimensional (3D) vertical array structure.

The memory cell array 410 may be divided into a plurality of memory blocks (e.g., first memory block BLK1, second memory block BLK2, to z-th memory block BLKz, wherein z is a positive integer greater than zero (0), hereinafter generally referred to as “BLK”). Each memory block of the plurality of memory blocks BLK may include memory cells. For example, the non-volatile memory 400 may include a plurality of blocks BLK, each of which includes a plurality of pages, and each of the plurality of blocks BLK may include a plurality of sub-blocks.

Referring to FIG. 5, the plurality of blocks BLK in the memory cell array 410 may be classified into three types of blocks. In some embodiments, the memory cell array 410 may be classified into user blocks 411, reserved blocks 413, and free blocks 415. In FIG. 5, the numbers of user blocks 411, reserved blocks 413, and free blocks 415 are shown relatively.

The user blocks 411 may refer to blocks in which a user may write data and/or from which a user may read data (e.g., blocks are readable and writeable). For example, the storage controller 300 may transmit a command CMD, an address ADDR, and/or data DATA, and perform an operation to write the data DATA in the user block 411, and/or perform an operation to read data DATA from the user block 411.

The reserved blocks 413 may refer to blocks in which the storage controller 300 cannot write data DATA and from which the storage controller cannot read data DATA (e.g., blocks are not readable and not writeable). The reserved blocks 413 may be bad blocks, and data DATA may not be possible to write in the reserved blocks 413 and read from the reserved blocks 413 due to a process error. In some embodiments, the number of reserved blocks 413 may not be changed.

The free blocks 415 may refer to blocks in which valid user data may not be currently stored. For example, the free blocks 415 may be and/or may include blocks on which an erasing operation has been completed and a programming operation may be performed again. In some embodiments, the free blocks 415 may be areas for performing garbage collection. For example, blocks which may be reused after a garbage collection operation is performed may be used as user blocks and/or as free blocks. In some embodiments, the number of reserved blocks 413 and the number of memory cell arrays 410 may not change, so the free blocks 415 may be changed according to the number of user blocks 411.

In some embodiments, the total sum of the numbers of memory blocks BLK in memory cell arrays 410 may be set in advance. That is, the sum of the numbers of user blocks 411, reserved blocks 413, and free blocks 415 may be set in advance. Alternatively or additionally, the same type of blocks may be positioned so as to be spaced apart in one memory cell array 410. The numbers of user blocks 411 and free blocks 415 in one storage device 30a may be set in advance.

In some embodiments, the numbers of user blocks, reserved blocks, and free blocks in the plurality of blocks may be represented by the numbers of assignable logical block addresses. In some embodiments, the numbers of blocks may be represented by the numbers of assignable sub logical block addresses and/or the numbers of assignable logical pages. However, the present disclosure is not limited thereto, and the numbers of blocks may be expressed using another arbitrary unit.

As described above, the block information may include the total number of blocks, the numbers of blocks corresponding to the individual types, and addresses corresponding to the individual block types. The FTL 320 may change the block information in response to a state change signal of the host device 20. That is, the FTL 320 may change addresses corresponding to the user blocks 411. As addresses assigned to the user blocks 411 and the free blocks 415 are changed, the FTL 320 may also change the mapping table for garbage collection.

For example, addresses ADDR1 to ADDR10 may be assigned to the first type blocks, which may be free blocks. That is, the first type blocks may be used for garbage collection, and even though a write instruction may be received from the host device 20, data may not be programmed in the first type blocks. However, when a state change signal instructing to change the type of the first type blocks to the second type is received from the host device 20, the FTL 320 may change the first type blocks to second type blocks, and change mapping data such that the addresses of the corresponding first type blocks are included in addresses corresponding to second type blocks. Thereafter, when a write instruction is received from the host device 20, data may be programmed in the first type blocks.

In an embodiment, a garbage collection level of the non-volatile memory 400 may be set in advance.

In some embodiments, the FTL 320 may determine that the current state of the non-volatile memory 400 exceeds the garbage collection level, on the basis of the internal state information on the non-volatile memory 400. In such embodiments, the FTL 320 may perform garbage collection by rearranging the memory blocks BLK of the non-volatile memory 400. For example, the FTL 320 may rearrange pages with data stored thereon, in at least one of the user blocks 411, and erase the existing blocks having the pages with the data stored thereon.

In another example of a storage system 10, the internal state information on the non-volatile memory 400 may exceed the garbage collection level often when data is written. Accordingly, the FTL 320 may perform frequent garbage collection, and the user may experience slowdown issues. For example, in the non-volatile memory 400 with a small number of free blocks 415, a relatively small number of memory blocks BLK may be used to handle garbage collection occurring during data writing, which may cause delay in the data writing. Consequently, garbage collection, which may be performed during data writing, may lead to a decrease in performance of the storage system 10. However, a case where the number of reserved blocks 413 exceeds a predetermined level may occur due to process issues. Since the total number of blocks in the memory cell array 410 may not change, as the number of reserved blocks 413 increases, the numbers of user blocks 411 and free blocks 415 may decrease. Accordingly, the storage device 30a may not provide optimal performance.

Returning to FIG. 4, the control circuit 460 may receive a command CMD and addresses ADDR from the storage controller 300 of FIG. 2. Alternatively or additionally, the control circuit 460 may control at least one of an erasing loop, a programming loop, and a read operations on the non-volatile memory 400, on the basis of the command CMD and the addresses ADDR.

For example, the control circuit 460 may generate control signals CON for controlling the voltage generator 450, and/or control signals PBC for controlling the page buffer circuit 430, on the basis of the command CMD. Alternatively or additionally, the control circuit 460 may generate row addresses R_ADDR and column addresses C_ADDR, on the basis of the addresses ADDR. The control circuit 460 may provide the row addresses R_ADDR to the address decoder 420, and/or provide the column addresses C_ADDR to the data I/O circuit 440.

The address decoder 420 may be coupled to the memory cell array 410 through the plurality of string select lines SSL, the plurality of word lines WL, and the plurality of ground select lines GSL.

For example, during an erasing/programming/read operation, in response to row addresses R_ADDR, the address decoder 420 may determine at least one of the plurality of word lines WL as selected word lines, and/or determine the other word lines of the plurality of word lines WL, excluding the selected word lines, as non-selected word lines.

Alternatively or additionally, during an erasing/programming/read operation, in response to row addresses R_ADDR, the address decoder 420 may determine at least one of the plurality of string select lines SSL as selected string select lines, and/or determine the other string select lines as non-selected string select lines.

Alternatively or additionally, during an erasing/programming/read operation, in response to row addresses R_ADDR, the address decoder 420 may determine at least one of the plurality of ground select lines GSL as selected ground select lines, and/or determine the other ground select lines as non-selected ground select lines.

In an embodiment, the voltage generator 450 may generate voltages VS that may be needed for the operation of the non-volatile memory 400, on the basis of power supply voltage PWR and control signals CON. For example, the voltages VS may be applied to the plurality of string select lines SSL, the plurality of word lines WL, and the plurality of ground select lines GSL through the address decoder 420. Alternatively or additionally, the voltage generator 450 may generate an erase voltage VERS that may be needed for an erasing operation, on the basis of the power supply voltage PWR and control signals CON. The erase voltage VERS may be applied to the memory cell array 410 directly and/or through the bit lines BL.

For example, during an erasing operation, the voltage generator 450 may apply the erase voltage VERS to a common source line and/or bit lines BL of one memory block, and apply an erase permission voltage (e.g., a ground voltage) to all word lines of one memory block and/or word lines corresponding to some sub-blocks through the address decoder 420.

For example, during a programming operation, the voltage generator 450 may apply a programming voltage to the selected word lines and apply a programming prohibition voltage to the non-selected word lines, through the address decoder 420.

The page buffer circuit 430 may be coupled to the memory cell array 410 through the plurality of bit lines BL. The page buffer circuit 430 may include a plurality of page buffers. In an embodiment, one bit line may be coupled to one page buffer. In optional or additional embodiments, two or more bit lines may be coupled to one page buffer.

The page buffer circuit 430 may store write data DATA to be programmed in the memory cell array 410. Alternatively or additionally, the page buffer circuit 430 may store read data DATA detected from the memory cell array 410. That is, the page buffer circuit 430 may operate as a write driver and/or a sense amplifier, depending on the operation mode of the non-volatile memory 400.

The data I/O circuit 440 may be coupled to the page buffer circuit 430 through data lines DL. The data I/O circuit 440 may provide write data DATA to the memory cell array 410 through the page buffer circuit 430, and/or provide read data DATA output from the memory cell array 410 through the page buffer circuit 430 to the outside, in response to the column addresses C_ADDR.

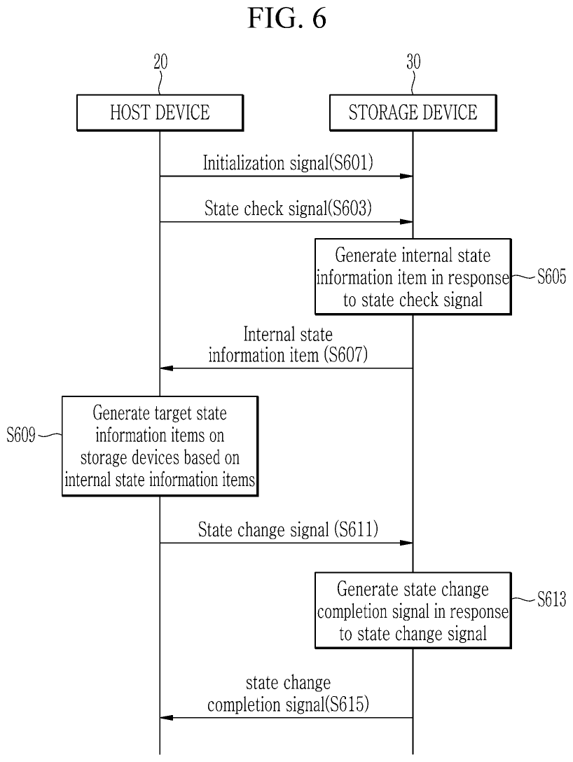

FIG. 6 is a flow chart illustrating the operation of the storage system, according to the embodiment.

The host device 20 may transmit an initialization signal to each of the plurality of storage devices 30 (operation S601).

The initialization signal may be and/or may include a signal for initializing the plurality of storage devices 30. For example, the host device 20 may transmit the initialization signal, as a request signal REQ, to the plurality of storage devices 30. As another example, the initialization signal may be and/or may include a signal including a sanitize command. Each of the plurality of storage devices 30 may initialize the internal non-volatile memory 400 in response to reception of the initialization signal.

The host device 20 may transmit a state check signal to each of the plurality of storage devices 30 (operation S603).

The state check signal may be and/or may include a signal for obtaining internal state information items on the plurality of individual storage devices 30.

Each of the plurality of storage devices 30 may generate an internal state information item, in response to the state check signal from the host device 20 (operation S605).

For example, each of the plurality of storage devices 30 may check the blocks of the internal non-volatile memory, and/or generate an internal state information item. Alternatively or additionally, each of the plurality of storage devices 30 may use an internal state information item stored in advance.

The storage device 30 may receive the state check signal from the host device 20, and transmit an internal state information item in response to the state check signal. The internal state information item may include block information on the non-volatile memory 400. Alternatively or additionally, the internal state information item may include information on the garbage collection level of the storage device 30. The garbage collection level may include data for setting a desirable garbage collection level according to the numbers of user blocks and free blocks of the storage device 30 as well as the current set garbage collection level of the storage device 30.

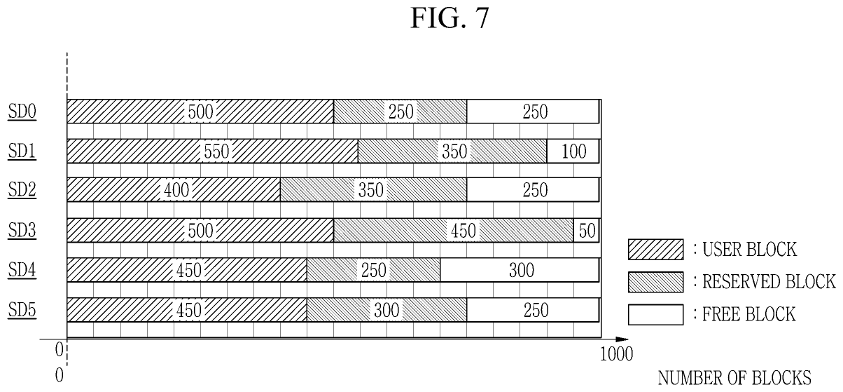

Operation S605 is further described with reference to FIG. 7.

FIG. 7 is a drawing illustrating an example format for internal state information items that may be respectively related to a plurality of storage devices, according to an embodiment. For example, each storage device 30 of the plurality of storage devices may transmit, to the host device 20, an internal state information item with a format similar to FIG. 7.

For example, in FIG. 7, internal state information items on a plurality of storage devices 30 (e.g., first storage device SD0, second storage device SD1, third storage device SD2, fourth storage device SD3, fifth storage device SD4, and sixth storage device SD5) are shown. For ease of explanation, it may be assumed for FIG. 7 that each of the first to sixth storage devices SD0 to SD6 includes 1,000 blocks. However, the present disclosure is not limited thereto, and the total number of blocks may be an arbitrary number. Further, FIG. 7 shows the internal state information items on the plurality of storage devices 30 as being generated on a block basis. However, the present disclosure is not limited thereto, and the internal state information items may be expressed in sub-block and/or logical page units and/or in arbitrary units.

The internal state information item on the first storage device SD0 may indicate that the first storage device SD0 includes 500 user blocks, 250 reserved blocks, and 250 free blocks.

The internal state information item on the second storage device SD1 may indicate that the second storage device SD1 includes 550 user blocks, 350 reserved blocks, and 100 free blocks.

The internal state information item on the third storage device SD2 may indicate that the third storage device SD2 includes 400 user blocks, 350 reserved blocks, and 250 free blocks.

The internal state information item on the fourth storage device SD3 may indicate that the fourth storage device SD3 includes 500 user blocks, 450 reserved blocks, and 50 free blocks.

The internal state information item on the fifth storage device SD4 may indicate that the fifth storage device SD4 includes 450 user blocks, 250 reserved blocks, and 300 free blocks.

The internal state information item on the sixth storage device SD5 may indicate that the sixth storage device SD5 includes 450 user blocks, 300 reserved blocks, and 250 free blocks.

Returning to FIG. 6, each of the plurality of storage devices 30 may transmit the generated internal state information item to the host device 20 (operation S607).

The host device 20 may generate target state information items on the plurality of storage devices 30, on the basis of the received internal state information items (operation S609).

In an embodiment, the target state information items may indicate block allocations to the plurality of storage devices 30, that when implemented by the plurality of storage devices 30, may cause the internal state information items of the plurality of storage devices 30 to be the same as (e.g., match) the target state information items.

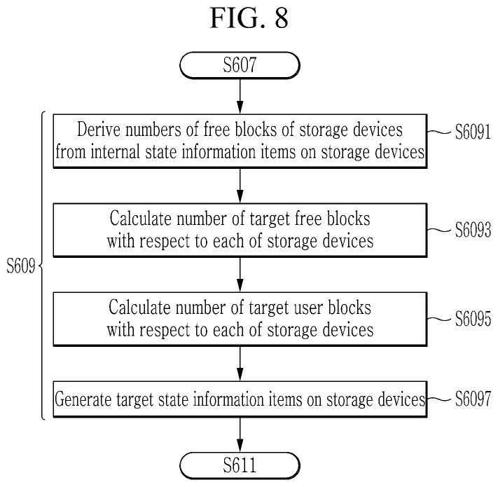

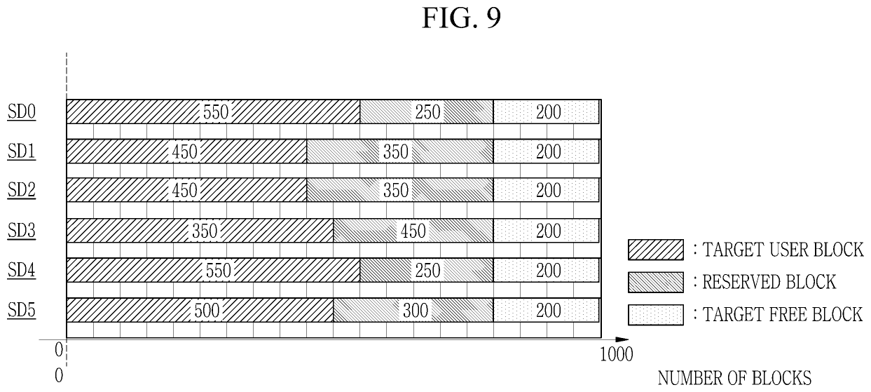

Operation S609 is further described with reference to FIGS. 8 and 9.

FIG. 8 is a flow chart illustrating the operation of the host device according to an embodiment. FIG. 9 is a drawing illustrating internal state information items on the plurality of individual storage devices, according to an embodiment.

For example, FIG. 8 is a flow chart illustrating a step in which the host device 20 generates target state information items (operation S609 of FIG. 6).

As shown in FIG. 8, the host device 20 may derive the numbers of free blocks of the plurality of storage devices 30, from the internal state information items on the plurality of individual storage devices 30 (operation S6091).

Using the values shown in FIG. 7 as an example, the host device 20 may derive that the first storage device SD0 includes 250 free blocks, that the second storage device SD1 includes 100 free blocks, that the third storage device SD2 includes 250 free blocks, that the fourth storage device SD3 includes 50 free blocks, that the fifth storage device SD4 includes 300 free blocks, and that the sixth storage device SD5 includes 250 free blocks, on the basis of the plurality of internal state information items received from the plurality of first to sixth storage devices SD0 to SD5

The host device 20 may calculate the number of target free blocks with respect to each of the plurality of storage devices 30 (operation S6093).

The numbers of target free blocks may be the numbers of free blocks which the plurality of storage devices 30 may need to include, respectively. For example, the host device 20 may calculate the numbers of target free blocks such that each storage device of the plurality of storage devices 30 has the same number of free blocks as the remaining storage devices of the plurality of storage devices 30.

In some embodiments, the number of target free blocks may be equal to the average number of free blocks obtained by dividing the total number of free blocks included in the plurality of storage devices 30 by the number of storage devices 30

$$( e . g . , {N}_{TARGET \_ FREE} = \frac{total number of free blocks}{n umber of storage devices} ) .$$

Referring to FIG. 9, the host device 20 may calculate 1200 as the total number of free blocks of the plurality of storage devices SD0 to SD5 (e.g., total number of free blocks=250+100+250+50+300+250=1200). Thereafter, the host device 20 may calculate 200 as the number of target free blocks by dividing 1200 which is the total number of free blocks by 6 which is the number of storage devices SD0 to SD5

$$( e . g . , {N}_{TARGET \_ FREE} = \frac{1200}{6} = 200 ) .$$

The host device 20 may calculate the number of target user block with respect to each of the plurality of storage devices 30 (operation S6095).

For example, the host device 20 may calculate the numbers of target user blocks of the plurality of storage devices 30 such that each of the plurality of storage devices 30 has a target free block value. Since the numbers of reserved blocks in the plurality of storage devices 30 do not change, the numbers of target user blocks may be values obtained by subtracting the numbers of target user blocks and the numbers of reserved blocks from the total numbers of blocks. Therefore, the host device 20 may change the number of free blocks of each of the plurality of storage devices 30 by changing the number of user blocks of each of the plurality of storage devices 30.

As shown in FIG. 9, the host device 20 may calculate 550 as the number of target user blocks of the first storage device SD0 by subtracting 200 which is the number of target free blocks of the first storage device SD0 and 250 which is the number of reserved blocks from 1000 which is the total number of blocks (e.g., N_{TARGET_USER}=1000−200−250=550). Similarly, the host device 20 may calculate 450, 450, 350, 550, and 500 as the number of target user blocks of the second storage device SD1, the number of target user blocks of the third storage device SD2, the number of target user blocks of the fourth storage device SD3, the number of target user blocks of the fifth storage device SD4, and the number of target user blocks of the sixth storage device SD5, respectively.

Returning to FIG. 8, the host device 20 may generate target state information items on the plurality of storage devices 30 (operation S6097).

The target state information items may include the numbers of target user blocks and the numbers of target free blocks related to the plurality of storage devices 30.

Referring to FIG. 9, the host device 20 may generate a target information item including 550 target user blocks and 200 target free blocks for the first storage device SD0, a target information item including 550 target user blocks and 200 target free blocks for the second storage device SD1, a target information item including 450 target user blocks and 200 target free blocks for the third storage device SD2, a target information item including 350 target user blocks and 200 target free blocks for the fourth storage device SD3, a target information item including 550 target user blocks and 200 target free blocks for the fifth storage device SD4, and a target information item including 500 target user blocks and 200 target free blocks for the sixth storage device SD5.

The target state information items may include information items on target garbage collection levels. A target garbage collection level may refer to a garbage collection level which the host device 20 determined with reference to data for setting a garbage collection level (e.g., data for setting a desirable garbage collection level according to the number of free blocks and the number of user blocks), when the data was received from a storage device 30. The host device 20 may determine a target garbage collection level on the basis of a target block information item and data for setting a garbage collection level and received from the storage device 30. Alternatively or additionally, the host device 20 may generate a target state information item including the garbage collection level and the target block information item.

The host device 20 may transmit a state change signal to each of the plurality of storage devices 30 on the basis of the target state information items (operation S611).

The state change signal may include the target state information items generated in operation S609.

The plurality of storage devices 30 generates state change completion signals in response to the state change signal (operation S613).

For example, the plurality of storage devices 30 may change the settings (e.g., block allocation) in the plurality of storage devices 30 such that the storage devices have block information corresponding to the target state information items included in the state change signal. Each of the plurality of storage devices 30 may generate a state change completion signal when the internal state information item and the target state information item are the same.

The plurality of storage devices 30 may transmit the state change completion signals to the host device 20 (operation S613).

The state change completion signals may be and/or may include signals indicating that the plurality of storage devices 30 has internal state information items corresponding to the target state information items.

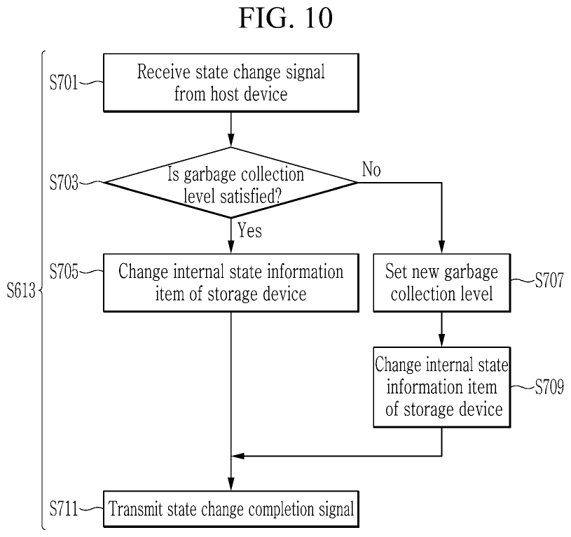

Operation S613 is further described with reference to FIG. 10.

FIG. 10 is a flow chart illustrating the operation of a storage device, according to the embodiment.

Referring to FIG. 10 a flow chart illustrating the operations by which the plurality of storage devices 30 may generate state change completion signals in response to the state change signal (operation S613) is shown.

The storage device 30 may receive the state change signal from the host device 20 (operation S701).

The storage device may determine whether a garbage collection level is satisfied (operation S703).

The storage device 30 may determine whether the numbers of user blocks and free blocks satisfy a garbage collection level set in advance in the storage device 30, on the basis of the target state information items. In some embodiments, when the number of free blocks in the target state information item is smaller than the number of free blocks in the corresponding storage device 30, the storage device 30 may determine that the garbage collection level is not satisfied (No in operation S703). Alternatively or additionally, when the number of free blocks is larger than the number of free blocks in the corresponding storage device 30, the storage device 30 may determine that the garbage collection level is satisfied (Yes in operation S703).

When the storage device 30 determines that the target state information item satisfies the garbage collection level of the storage device 30, the storage device may change the internal state information item of the storage device on the basis of the target state information items (operation S705).

The storage device 30 may change the internal state information item such that the internal state information item has the number of target free blocks and the number of target user blocks included in the target state information item received by the storage device 30. For example, the storage device 30 may change the number of user blocks and/or addresses assigned to the user blocks. Accordingly, the storage device 30 may change the number of free blocks, and addresses assigned to the free blocks. Alternatively or additionally, the storage device 30 may change the mapping table for performing garbage collection on the storage device 30.

The storage device 30 may transmit a state change completion signal to the host device 20 (operation S711).

When the storage device 30 determines that the target state information item does not satisfy the garbage collection level of the storage device 30, the storage device sets a new garbage collection level (operation S707).

In some embodiments, the storage device 30 may set a new garbage collection level based on the target state information item.

For example, the host device 20 may transmit a target garbage collection level together with a target block information item, as a state change signal, to the storage device 30. The storage device 30 may change the garbage collection level to the received target garbage collection level.

When the host device 20 does not transmit a target garbage collection level as a state change signal to the storage device 30, the storage device 30 may set a new garbage collection level based on the target block information item. That is, information on a garbage collection level according to a change in the number of free blocks may be stored in advance in the storage device 30. For example, the information on a garbage collection levels that is stored in advance may be used by the storage device 30 for setting the garbage collection levels such that when the number of free blocks falls within a first range, the storage device 30 has a first garbage collection level, and/or when the number of free blocks falls within a second range, the storage device 30 has a second garbage collection level. Alternatively or additionally, the information on a garbage collection levels that is stored in advance may be used by the storage device 30 for setting the garbage collection levels such that when the number of free blocks decreases by 10%, the storage device 30 has a first garbage collection level, and when the number of free blocks decreases by 20%, the storage device 30 has a second garbage collection level.

The following description will be made taking the fifth storage device SD4 of FIG. 7 as an example. It may be assumed that the fifth storage device SD4 has a garbage collection level set such that the when number of free blocks is smaller (e.g., less) than or equal to 250, garbage collection may be performed. In such an example, since the fifth storage device SD4 includes 300 free blocks until receiving a state change signal from the host device 20, the garbage collection level is satisfied. That is, the fifth storage device SD4 does not satisfy a condition for performing garbage collection, until receiving a state change signal. However, the fifth storage device may receive a state change signal in which the number of target free blocks is 200, from the host device 20. In such an example, if the number of free blocks is changed according to the number of target free blocks, the number of free blocks which are included in the fifth storage device SD4 may exceed the garbage collection level, and it may be determined that the fifth storage device SD4 does not satisfy the garbage collection level. Accordingly, the fifth storage device SD4 may set a new garbage collection level. For example, the fifth storage device SD4 may set the received number of target free blocks as a new garbage collection level. That is, the fifth storage device SD4 may set a garbage collection level such that when the number of free blocks is smaller (e.g., less) than or equal to 200, garbage collection may be performed.

Returning to FIG. 10, the storage device 30 may change the internal state information item on the storage device, on the basis of the target state information item (operation S709).

The storage device 30 may change the internal state information item such that the changed internal state information item corresponds to the new garbage collection level set in operation S607 and the target block information item received in operation S601.

The storage device 30 may transmit a state change completion signal to the host device 20 (operation S711).

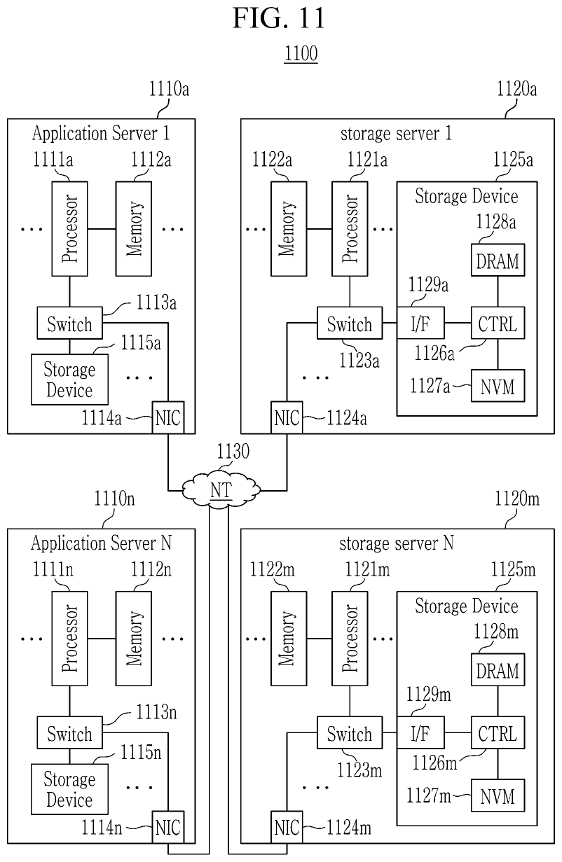

FIG. 11 is a block diagram illustrating a data center to which the storage system has been applied, according to an embodiment.

Referring to FIG. 11, a data center 1100 may be and/or may include a facility that may collect a variety of data and/or provide services. In some embodiments, the data center 1100 may be referred to as a data storage center. The data center 1100 may be and/or may include a system for operating search engines and databases, and/or may be a computing system which may be used in an entity, such as, but not limited to, a company, a bank, a government agency, and the like. The data center 1100 may include application servers (e.g., first application server 1 1110a, to n-th application server N 1110n, where n is a positive integer greater than zero (0), hereinafter generally referred to as “1110”) and storage servers (e.g., first storage server 1 1120a, to m-th storage server M 1120m, where m is a positive integer greater than zero (0), hereinafter generally referred to as “1120”). The number of application servers 1110 (e.g., n) and the number of storage servers 1120 (e.g., m) may be selected variously according to embodiments and/or design constraints. In an embodiment, the number of application servers 1110 and the number of storage servers 1120 may be different from each other (e.g., n≠m).

The application servers 1110 and the storage servers 1120 may include at least one of processors 1111 and 1121 and memories 1112 and 1122, respectively. A storage server 1120 is described as an example. A processor 1121 may control the overall operation of the storage server 1120. For example, the processor 1121 may access a memory 1122, and/or may execute instructions and/or data loaded in the memory 1122. The memory 1122 may be and/or may include a double data rate synchronous DRAM (DDR SDRAM), a high bandwidth memory (HBM), a hybrid memory cube (HMC), a dual in-line memory module (DIMM), an Optane DIMM, and/or a non-volatile DIMM (NVMDIMM). Depending on embodiments, the numbers of processors 1121 and memories 1122 which are included in the storage server 1120 may be selected variously. In an embodiment, a processor 1121 and a memory 1122 may provide a processor-memory pair. In an embodiment, the numbers of processors 1121 and memories 1122 may be different from each other. The processors 1121 may include single-core processors or multi-core processors. The above description of the storage servers 1120 may be similarly applied to the application servers 1110. Depending on embodiments the application servers 1110 may not include storage devices 1115. Each storage server 1120 may include at least one storage device 1125. The numbers of storage devices 1125 which are included in the storage servers 1120 may be selected variously depending on embodiments.

The application servers 1110 and the storage servers 1120 may perform communication with one another through a network 1130. The network 1130 may be implemented using Fiber Channel (FC), Ethernet, and the like. In an embodiment, FC may be and/or may include a medium which may be used for relatively high speed data transmission, and/or may use optical switches which may provide high performance/high availability. Depending on the access method of the network 1130, the storage servers 1120 may be provided as file storages, block storages, object storages, and the like.

In an embodiment, the network 1130 may be a network dedicated for storages, such as a storage area network (SAN).

For example, the SAN may be and/or may include a FC-SAN using a FC network and/or may be implemented according to an FC protocol (FCP). As another example, the SAN may be and/or may include an IP-SAN using a TCP/IP network and/or may be implemented according to a SCSI over TCP/IP and/or Internet SCSI (iSCSI) protocol. In an optional or additional embodiment, the network 1130 may be a general network, such as a TCP/IP network. For example, the network 1130 may be implemented to conform to at least one communication protocol, such as, but not limited to, FC over Ethernet (FCoE), network attached storage (NAS), and NVMe over Fabrics (NVMe-oF), and the like.

The following description may be made with a focus on the application servers 1110 and the storage servers 1120. A description of an application server 1110 may be applied to the other application servers 1110, and a description of a storage server 1120 may be applied to the other storage servers 1120.

The application servers 1110 may store data requested to be stored by a user and/or a client, in one of the storage servers 1120, through the network 1130. Alternatively or additionally, the application servers 1110 may obtain data requested to be read by a user or a client, from one of the storage servers 1120, through the network 1130. For example, the application servers 1110 may be implemented as web servers, database management systems (DBMs), and the like.

Each application server 1110 may access memories 1112 and/or storage devices 1115 included in the other application servers 1110, through the network 1130, and/or may access memories 1122 and/or storage devices 1125 included in the storage servers 1120, through the network 1130. Accordingly, the application servers 1110 may perform various operations on data stored in the application servers 1110 and/or the storage servers 1120. For example, the application servers 1110 may execute instructions for moving and/or copying data between the application servers 1110 and/or the storage servers 1120. In such an example, data may be moved from the storage devices 1125 of the storage servers 1120 to the memories 1112 of the application servers 1110, directly and/or via the memories 1122 of the storage servers 1120. Data moved through the network 1130 may be encrypted for security and/or privacy.

In a storage server 1120 to be described as an example, an interface 1129 may provide a physical connection of a processor 1121 and a controller 1126 and a physical connection of an NIC 1124 and the controller 1126. For example, the interface 1129 may be implemented in a direct attached storage (DAS) scheme in which the storage device 1125 may be directly connected with a dedicated cable. For example, the interface 1129 may be implemented in various interface schemes, such as, but not limited to, ATA, SATA, external SATA (e-SATA), SCSI, SAS, PCI, PCIe, NVMe, Institute of Electrical and Electronics Engineers (IEEE) 1394 (FireWire), USB, SD card, MMC, eMMC, UFS, embedded universal flash storage (eUFS), CF card interfaces, and the like.

The storage server 1120 may further include a switch 1123 and the NIC 1124. The switch 1123 may selectively connect the processor 1121 and the storage device 1125 and/or selectively connect the NIC 1124 and the storage device 1125, under the control of the processor 1121. Similarly, the application servers 1110 may further include switches 1113 and NICs 1114.

In an embodiment, the NIC 1124 may include a network interface card, a network adapter, and the like. The NIC 1124 may be connected to the network 1130 by at least one of a wired interface, a wireless interface, a Bluetooth interface, an optical interface, and the like. The NIC 1124 may include an internal memory, a digital signal processor (DSP), a host bus interface, and the like. Alternatively or additionally, the NIC 1124 be connected to the processor 1121 and/or the switch 1123 through the host bus interface. The host bus interface may be implemented with one of the above-described examples of the interface 1129. In an embodiment, the NIC 1124 may be integrated with at least one of the processor 1121, the switch 1123, and the storage device 1125.

The processors in the storage servers 1120 or the application servers 1110 may transmit commands to the storage devices 1115 and 1125 and/or the memories 1112 and 1122, thereby being capable of programming (e.g., writing) and/or reading data. In such an embodiment, data may be and/or may include data subjected to error correction by an error correction code (ECC) engine. Alternatively or additionally, the data may be subjected to data bus inversion (DBI) and/or data masking (DM), and may include cyclic redundancy code (CRC) information.

The storage devices 1125 may transmit control signals and command/address signals to NAND flash memory devices 1127 in response to read commands received from the processors. Accordingly, when data is read from the NAND flash memory devices 1127, a read enable RE signal may be input as a data output control signal such that data is output to a DQ bus. The RE signal may be used to generate a data strobe (DQS). Command and address signals may be latched in page buffers depending on rising edges or falling edges of a write enable (WE) signal.

The controller 1126 may generally control the operation of the storage device 1125. In an embodiment, the controller 1126 may include a static random access memory (SRAM). The controller 1126 may write data in the NAND flash memory devices 1127 in response to write commands, and/or read data from the NAND flash memory devices 1127 in response to read commands. For example, write commands and/or read commands may be provided from the processor 1121 in the storage server 1120, the processors 1121 in other storage servers 1120, or processors 1111 in the application servers 1110. A DRAM 1128 may temporarily store data to be written in the NAND flash memory devices 1127 and/or data read from the NAND flash memory devices 1127. Alternatively or additionally, the DRAM 1128 may store metadata. Here, metadata may refer to user data and/or data generated in the controller 1126 to manage the NAND flash memory device 1127.

The storage devices 1125 may be implemented on the basis of the storage device, according to embodiments of the present disclosure described above with reference to FIGS. 1 to 10, and may be implemented so as to perform the operating method according to the embodiments of the present disclosure.

In some embodiments, the storage devices 1125 may include bad blocks. However, the application servers 1110 may be able to similarly adjust the numbers of free blocks of the storage devices 1125. In such a case, the storage devices 1125 may be similar in their performance of performing garbage collection. Therefore, it may take similar times to access a plurality of storage devices included in one storage system. Accordingly, it may be possible to provide uniform performance in the data center 1100.

The embodiments of the present disclosure may be used in storage devices, and arbitrary electronic devices and systems including them. For example, the embodiments of the present disclosure may also be applied to electronic systems such as personal computers (PCs), server computers, data centers, workstations, laptops, cellular phones, smart phones, MP3 players, personal digital assistants (PDAs), portable multimedia players (PMPs), digital television sets, digital cameras, portable game consoles, navigation devices, wearable devices, Internet of things (IoT) devices, Internet of everything (IoE) devices, e-books, virtual reality (VR) devices, augmented reality (AR) devices, drones, and the like.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. A storage system, comprising:
a plurality of storage devices, each storage device of the plurality of storage devices comprising a plurality of blocks classified into first type blocks, second type blocks, and third type blocks, and configured to generate internal state information items indicating information on a first number of first type blocks, a second number of second type blocks, and a third number of third type blocks; and
a host device configured to:
receive, from the plurality of storage devices, the internal state information items;
generate target state information such that the plurality of storage devices comprise a same number or substantially same number of first type blocks, based on the internal state information items; and
transmit, to the plurality of storage devices, the target state information.

2. The storage system of claim 1, wherein the first type blocks are configured to perform garbage collection of the plurality of storage devices,
wherein the second type blocks are configured as not readable and not writeable blocks, and
wherein the third type blocks are configured as readable and writeable blocks.

3. The storage system of claim 2, wherein the first number of first type blocks, the second number of second type blocks, and the third number of third type blocks corresponds to at least one of:
a fourth number of assignable logical block addresses;
a fifth number of assignable sub logical block addresses; and
a sixth number of assignable logical pages.

4. The storage system of claim 1, wherein the target state information comprises a first target number corresponding to the third type blocks related to a first storage device of the plurality of storage devices, and
wherein the first storage device is configured to change the third number of third type blocks in the plurality of blocks of the first storage device, such that an updated third number of third type blocks indicated by an updated internal state information item is the same or substantially similar as the first target number of the target state information.

5. The storage system of claim 4, wherein the target state information further comprises a second target number corresponding to the second type blocks related to the first storage device, and
wherein the first storage device is configured to change the second number of second type blocks in the plurality of blocks of the first storage device, such that an updated second number of second type blocks indicated by the updated internal state information item is equal to or substantially same as the second target number.

6. The storage system of claim 1, wherein each storage device of the plurality of storage devices comprises a flash translation layer (FTL) configured to generate the internal state information items, and
wherein the FTL is configured to perform garbage collection when an available memory area in a corresponding storage device exceeds a preset garbage collection level.

7. The storage system of claim 6, wherein the FTL is further configured to:
set, based on the preset garbage collection level not being satisfied, a new garbage collection level in a preset manner by adjusting at least one of a first target number of first type blocks, a second target number of second type blocks, and a third target number of third type blocks in the target state information.

8. The storage system of claim 6, wherein the FTL is further configured to:
change an address mapping table assigned to each of the first type blocks, the second type blocks, and the third type blocks, based on the target state information.

9. A server, comprising:
a communication unit configured to receive a plurality of internal state information items from a plurality of storage devices, each storage device of the plurality of storage devices comprising a memory cell array comprising a plurality of blocks, each internal state information item of the plurality of internal state information items comprising information on a first number of first type blocks of the plurality of blocks configured to perform garbage collection, a second number of second type blocks of the plurality of blocks configured as not readable and not writable, and a third number of third type blocks which are writable and readable; and
a controller configured to set, by generating target state information, a first target number of first type blocks and a third target number of third type blocks in each storage device of the plurality of storage devices, based on the plurality of internal state information items.

10. The server of claim 9, wherein the controller is further configured to:
generate the target state information such that the first target number of first type blocks for the plurality of storage devices are equal to or substantially the same as each other.

11. The server of claim 9, wherein the controller is further configured to:
generate the target state information by changing third target numbers of third type blocks such that the plurality of storage devices comprise a same number or substantially same number of the first type blocks.

12. The server of claim 11, wherein the plurality of internal state information items further comprises information indicating garbage collection levels for performing the garbage collection.

13. The server of claim 12, wherein the controller is further configured to:
determine a garbage collection level for each storage device of the plurality of storage devices, based on the information indicating the garbage collection levels and the target state information.

14. The server of claim 9, wherein the first number of first type blocks, the second number of second type blocks, and the third number of third type blocks corresponds to at least one of:
a fourth number of assignable logical block addresses;
a fifth number of assignable sub logical block addresses; and
a sixth number of assignable logical pages.

15. An operating method of a storage system, comprising:
transmitting, by a host device to a plurality of storage devices, a state check signal;
receiving, from the plurality of storage devices by the host device, internal state information items comprising information on a first number of first type blocks of a corresponding storage device configured to perform garbage collection, a second number of second type blocks of the corresponding storage device configured as not readable and not writable, and a third number of third type blocks configured as readable and writeable;
generating, by the host device, target state information for each storage device of the plurality of storage devices such that the plurality of storage devices comprise a same number or substantially same number of first type blocks, based on the internal state information items of the plurality of storage devices; and
transmitting, by the host device to the plurality of storage devices, a state change signal comprising the target state information and instructing the plurality of storage devices to change the internal state information items such that each storage device of the plurality of storage devices matches the target state information.

16. The operating method of claim 15, wherein the generating of the target state information comprises:
setting a first target number of first type blocks in the target state information to an average of the first number of first type blocks in the plurality of storage devices.

17. The operating method of claim 15, wherein the generating of the target state information comprises:
deriving the first number of first type blocks of the plurality of storage devices from the internal state information items of the plurality of storage devices;
calculating a first target number of first type blocks for each storage device of the plurality of storage devices;
calculating a third target number of third type blocks for each of the plurality of storage devices; and
generating the target state information for each storage device of the plurality of storage devices.

18. The operating method of claim 17, further comprising:
receiving, by the host device from each storage device of the plurality of storage devices, a state change completion signal that has been generated based on reception of the state change signal.

19. The operating method of claim 18, wherein the target state information comprises a first target number corresponding to the first type blocks and a third target number corresponding to the third type blocks for a first storage device of the plurality of storage devices, and
wherein the receiving of the state change completion signal comprises:
determining whether a garbage collection level of the first storage device is satisfied, based on the first target number corresponding to the first type blocks of the first storage device and the third target number corresponding to the third type blocks of the first storage device; and
changing the third target number of the third type blocks such that the third number of third type blocks in the internal state information items is the same as or substantially the same as to the third target number of the third type blocks in the target state information, when the garbage collection level of the first storage device is satisfied.

20. The operating method of claim 19, wherein the receiving of the state change completion signal further comprises:
setting a new garbage collection level based on the first target number corresponding to the first type blocks and the third target number corresponding to the third type blocks, when the garbage collection level of the first storage device is not satisfied.
